(19) United States
(12) Patent Application Publication
(10) Pub. No.: US 2010/0277591 A1
(43) Pub. Date: Nov. 4, 2010

(54) PORTABLE CAMERA AND SURVEILLANCE DEVICE

(76) Inventor: JERRY KOWALSKY, Irvine, CA (US)

Correspondence Address: JAFARI LAW GROUP, P.C., 801 N. PARKCENTER DRIVE, SUITE 220, SANTA ANA, CA, 92705, US

(21) Appl. No.: 12/432,459

(22) Filed: Apr. 29, 2009

(51) Int. Cl. H04N 7/18

(52) U.S. Cl. 348/158; 348/E07.085

(57) ABSTRACT

The invention is a portable camera and surveillance device adapted to attach to a plurality of distinct support structures and transmit an image signal. More particularly, an apparatus in accordance with the present invention comprises a housing including a universal connector capable of securely attaching to a plurality of distinct support structures, an image-capturing element disposed within the housing, wherein the image-capturing element is adapted to generate an image signal in response to detecting electromagnetic energy, and a transmitter disposed within the housing, wherein the transmitter is adapted to transmit the image signal. Distinct support structures may include a pole, weapon, helmet, or other device adapted to receive a universal connector.

### TECHNICAL FIELD OF THE INVENTION

The present invention relates in general to a portable camera and surveillance device, and more specifically, to a portable camera adapted to attach to a plurality of distinct support structures and transmit an image signal.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Law enforcement personnel rely upon their senses in order to perform their jobs. What an officer can see, hear, and smell play critical roles in their decision-making ability. As such, law enforcement agencies regularly embrace technology, as new technology that enables the collection of more accurate information allows an officer to make faster, safer and better informed decisions.

Because safety is one of the primary concerns for law enforcement personnel, the utilization of video surveillance equipment in potentially dangerous or hostile situations allows law enforcement personnel to see what they are up against. Without surveillance equipment, law enforcement officers frequently encounter situations wherein line of sight of a desired person, location or object can only be retrieved from a position that may be inaccessible, inconvenient, or unsafe. Thus, there is a need for surveillance devices that provide video access to viewpoints that would be traditionally inaccessible, inconvenient, or unsafe.

Video surveillance equipment, in conjunction with communications equipment, further allows for better coordination between law enforcement officers and other personnel. Better coordination and communication will lead to more intelligent decision-making, which likely yields increases in safety and deceases in error. Because law enforcement personnel frequently encounter situations wherein they are unable to describe what they observe, there is a need for surveillance equipment that allows for better coordination between law enforcement officers.

Law enforcement personnel, while they would like to embrace the most technologically advanced equipment possible, are frequently restricted by high cost. Therefore, surveillance equipment that is multi-functional provides higher cost effectiveness when used by a law enforcement agency. Additionally, multi-functional equipment allows for an officer to carry less equipment, thus easing their equipment burden in the field. As such, there is a need for surveillance equipment that is either low cost or multi-functional.

Thus, there is a need in the art for a portable camera and surveillance device. Specifically, there is a need for a portable camera that is multi-functional, allows for coordination between officers and provides remote sight access to traditionally inaccessible or dangerous viewpoints. It is to these ends that the present invention has been developed.

### SUMMARY OF THE INVENTION

To minimize the limitations in the prior art, and to minimize other limitations that will be apparent upon reading and understanding the present specification, the present invention describes a portable camera, comprising a housing including a universal connector capable of securely attaching to a plurality of distinct support structures, an image-capturing element disposed within the housing, wherein the image-capturing element is adapted to generate an image signal in response to detecting electromagnetic energy, and a transmitter disposed within the housing, wherein the transmitter is adapted to transmit the image signal.

The present invention further describes a law enforcement aid comprising an extendable and retractable pole, and a portable camera, comprising a housing including a universal connector for securely attaching to the pole, an image-capturing element disposed within the housing, wherein the image-capturing element is adapted to generate an image signal in response to detecting electromagnetic energy, and a transmitter disposed within the housing, wherein the transmitter is adapted to transmit the image signal.

The present invention further describes a law enforcement aid comprising a weapon, and a portable camera, comprising a housing including a universal connector for securely attaching to the weapon, an image-capturing element disposed within the housing, wherein the image-capturing element is adapted to generate an image signal in response to detecting electromagnetic energy, and transmitter disposed within the housing, wherein the transmitter is adapted to transmit the image signal.

The present invention further describes a camera surveillance system comprising a plurality of portable cameras, each comprising a housing including a universal connector capable of securely attaching to a plurality of distinct support structures, an image-capturing element disposed within the housing, wherein the image-capturing element is adapted to generate an image signal in response to detecting electromagnetic energy, and a transmitter disposed within the housing, wherein the transmitter is adapted to transmit the image signal, and a portable receiver adapted to receive the image signal from each of the cameras, and provide a corresponding image on a display.

It is an objective of the present invention to provide a portable camera that may be securely attached to a plurality of distinct support structures.

It is another objective of the present invention to provide a user safe and convenient visual access to areas traditionally inaccessible, inconvenient, or unsafe.

It is yet another objective of the present invention to provide law enforcement officers with a lightweight, portable surveillance device.

Finally, it is yet another objective of the present invention to provide a user with images from a plurality of portable cameras.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) is a simplified illustration of a left side elevational view of the interior components of an exemplary embodiment of the present invention.

FIG. 1(b) illustrates a simplified illustration of a rear perspective view of an exemplary embodiment of the present invention.

FIG. 2 illustrates exemplary use of a portable camera surveillance device in accordance with the present invention.

FIG. 3(a) illustrates a side view of an exemplary embodiment of a law enforcement aid.

FIG. 3(b) illustrates a side view of another exemplary embodiment of a law enforcement aid.

FIG. 4 illustrates a perspective view of an exemplary embodiment of a law enforcement aid.

FIG. 5(a) illustrates an overhead view of exemplary use of a camera surveillance system.

FIG. 5(b) illustrates a front elevational view of a portable receiver in a camera surveillance system.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

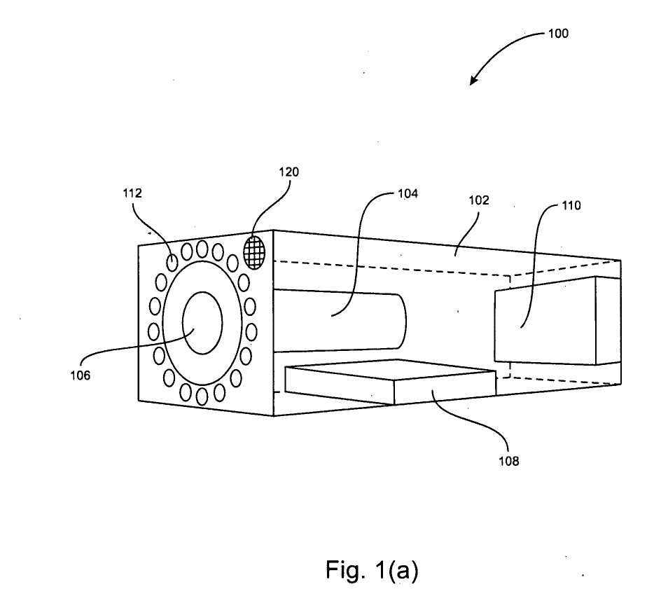

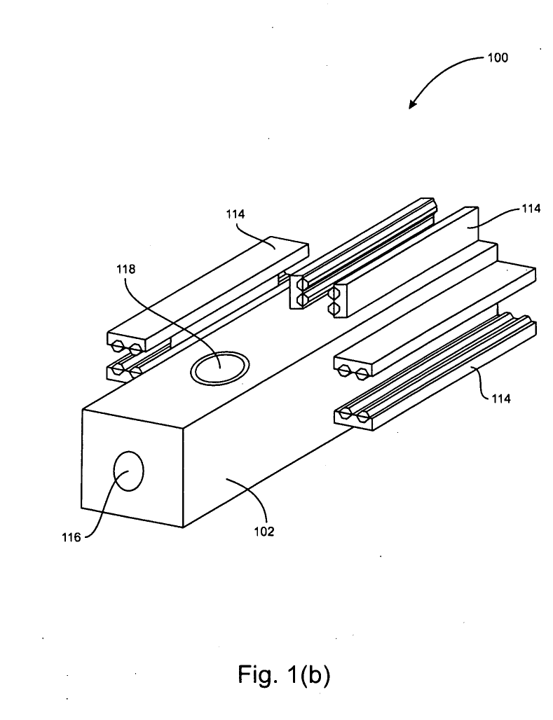

FIG. 1(a) is a simplified illustration of a left side elevational view of the interior components of an exemplary embodiment of the present invention. FIG. 1(b) illustrates a simplified illustration of a rear perspective view of an exemplary embodiment of the present invention.

FIGS. 1(a) and 1(b) show portable camera 100, comprising housing 102, camera 104, lens 106, transmitter 108, power source 110, lighting 112, universal connecter 114, secondary connecter 116, power switch 118, and audio recording component 120. Portable camera 100 is designed to transmit still or video images generated by camera 104 through lens 106, as well as the corresponding audio feedback generated by audio recording component 120, but to also allow for the secure attachment and removal of portable camera 100 to a plurality of distinct support structures, enabling a user to combine a variety of components to achieve the functionality of single purpose equipment.

Housing 102 is the main body of portable camera 100. Housing 102 is an object designed to be easily and securely attached to and removed from a plurality of distinct support structures, such as the end of a pole, on the front of a helmet, or on a surface or other portion of a weapon. In an exemplary embodiment, housing 102 may couple to a plurality of distinct support structures, but to also allow for image generation and transmission when portable camera 100 is in use. In an exemplary embodiment, housing 102 may be rectangular in shape; however, in other embodiments, housing 102 may be cylindrical, conical, cubical, or other shape configuration.

Housing 102 may be composed of a variety of materials, such as metals, plastics, or alloys. This list is not exhaustive, however, and should not be interpreted so as to limit the scope of the present invention. In an exemplary embodiment, the material used in the composition of housing 102 may be rigid so as to maintain a pre-molded shape, but to also be sufficiently lightweight and durable to withstand frequent use. Further, housing 102 may absorb or dampen the force of sudden movement, thereby protecting portable camera 100's interior components for image generation and transmission. Additionally, housing 102 may also be composed of a material able to shield portable camera 100's interior components from damage by heat radiated by an exterior source.

Camera 104 is a component of portable camera 100 situated within housing 102. Camera 104 is designed to generate or capture still or moving images illustrative of a portion of the electromagnetic spectrum that enters portable camera 100 via lens 106. Lens 106 is a component of camera 104 located in front of camera 104's opening, planar to housing 102. In an exemplary embodiment, lens 106 may gather light and focus it for processing. Additionally, camera 104 may be fixed focus, or have auto focus or rangefinder capabilities. In an exemplary embodiment, camera 104 may function through digital means; however, camera 106 may capture images through analog technology.

In an exemplary embodiment, camera 104 may generate images of the visible portion of the electromagnetic spectrum. However, in another embodiment, camera 104 may generate images of the infrared, or another portion of the electromagnetic spectrum. As such, camera 104 may capture images through a range of luminosity. In an exemplary embodiment, camera 104 may capture images in the infrared portion of the electromagnetic spectrum, which may be useful in situations with low levels of visible light (e.g. night-vision). Further, camera 104 may generate images in color, black and white, or other types of image output.

Audio recording component 120, which is part of portable camera 100, may be situated proximate to lens 106 and lighting 112 of housing 102. Audio recording component 120 is designed to record audio feedback received concurrent with the still or moving images recorded by camera 104. In one embodiment, audio recording component 120 is a microphone adapted to record audio feedback. In another embodiment, audio recording component 120 may record audio feedback by means of analog or digital recordings without limiting the scope of the present invention.

Transmitter 108 is a component of portable camera 100 designed to transmit images generated by camera 104. Transmitter 108 may be located within housing 102, or in another embodiment, may be external to housing 102. Transmitter 108 is connected to camera 104 such that transmitter 108 may transmit images generated by camera 104. In an exemplary embodiment, transmitter 108 may transmit on the industrial, scientific, and medical radio (ISM) bands. However, transmitter 108 may be configured to transmit on a wide number of other electromagnetic frequencies. Further, transmitter 108 may be configured to wirelessly interface directly with a remote device, i.e. Bluetooth protocol, or may be configured to transmit utilizing a wireless network protocol.

Power source 110 supplies portable camera 100 with power. Power source 110 may be contained within housing 102. Power source 110 may comprise a battery. In an exemplary embodiment, power source 110 may be rechargeable. In such an embodiment, power source 110 may include a charging port, or other connection type interface for recharging. In an alternative embodiment, power source 110 may be removable, such that power source 110 is removed from portable camera 100 for recharging. In yet another embodiment, power source 110 may be disposable, such that power source 110 may be replaced when its charge has been depleted. Power source 110 may be connected to camera 104 and transmitter 108.

Lighting 112 is a component of portable camera 100. Lighting 112 is a light source that emits energy in the visible portion of the electromagnetic spectrum. In an exemplary embodiment, lighting 112 may contain a light emitting diode; however, lighting 112 may emit light by way of a filament, and the method of light emission should not limit the scope of the present invention. Portable camera 100, however, need not include lighting 112.

In the present embodiment of portable camera 100, which includes lighting 112, lighting 112 may provide a light source for camera 104 in environments with low relatively levels of light. In an exemplary embodiment, lighting 112 may be contained within housing 102, with the light emitter planar to housing 102. Alternatively, lighting 112 may be situated external to housing 102. Preferably, lighting 112 may be powered by power source 110.

Universal connecter 114 is a component of portable camera 100 that is designed to couple with a plurality of distinct support structures. In an exemplary embodiment, portable camera 100 may contain a plurality of universal connectors 114, each located on a different surface of housing 102. Universal connector 114 is coupled to housing 102 such that portable camera 100 may be removably attached to an external support structure via universal connector 114. Universal connector 114 may comprise a picatinny rail mount, or another standardized mount type specification so as to be compatible with a plurality of connection devices.

In an exemplary embodiment of the present invention, universal connector 114 may comprise a first rail adapted to slide upon a corresponding second rail on an external support structure, with a locking mechanism to securely attach the first and second rails together. In an exemplary embodiment, the locking mechanism of universal connector 114 may be engaged or disengaged by a user, such that portable camera 100 may be securely attached and removed from the distinct support structure. In the present invention, the locking mechanism of universal connector 114 may be engaged by sliding a first rail and a second rail together, until the locking mechanism clicks into place. The locking mechanism of universal connector 114 may be disengaged mechanically, whereby a user may press or push a latch, disengaging the lock and allowing the user to slide the first rail off of the second rail. In other embodiments, however, the locking mechanism of universal connector 114 may function by electrical or other type of method, and thus the method of locking of universal connector 114 should not be interpreted so as to limit the present invention.

Universal connector 114 may be composed of a variety of materials, such as metals, plastics, or alloys. This list is not exhaustive, however, and should not be interpreted so as to limit the scope of the present invention. In an exemplary embodiment, universal connector 114 may be composed of a material so as to be sufficiently rigid to maintain portable camera 100's connection to the support device, durable to withstand frequent use, and able to absorb or dampen the force of sudden movement. Additionally, universal connector 114 may also be composed of a material able to withstand heat radiated by an exterior source, such as a support structure.

Secondary connecter 116 provides an alternative means connection for portable camera 100 to couple with a plurality of distinct support structures. Secondary connector 116 may be situated upon housing 102. In the present embodiment, secondary connector 116 is composed of a male and female screw-type configuration. Alternatively, secondary connector 116 may comprise some other type of connection method. As such, the type of connection utilized by secondary connector 116 should not be interpreted so as to limit the scope of the present invention.

Power switch 118 is a component of portable camera 100. Power switch 118 designed to allow the user to turn on and off the components of portable camera 100. In an exemplary embodiment, power switch 118 may comprise a switch, knob, compressible button, or some other type of component such as to provide the user a means of switching portable camera 100 on and off. In exemplary usage of portable camera 100, activating power switch 118 while portable camera 100 is in an off state would turn portable camera 100 on, while activating power switch 118 while portable camera 100 is in an on state would turn portable camera 100 off.

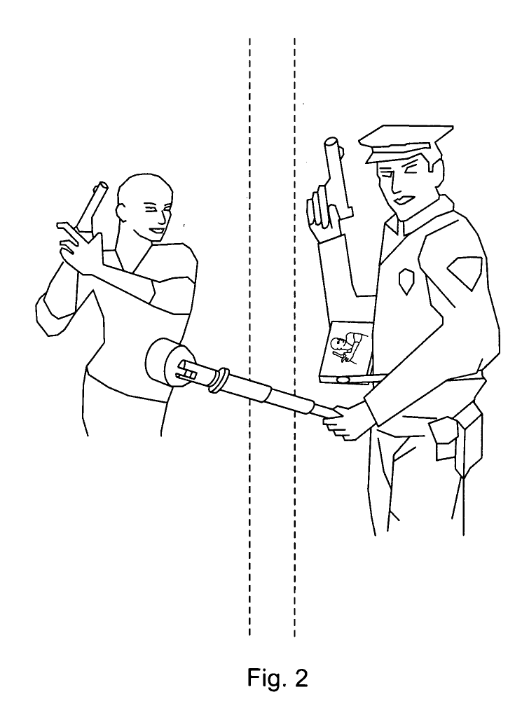

FIG. 2 illustrates exemplary use of a portable camera surveillance device in accordance with the present invention. As illustrated in FIG. 2, exemplary use of the present invention may include using a portable camera surveillance device to capture and transmit visual images around an obstacle. In the present illustration, a police officer is using a law enforcement aid, to be described in detail below, to transmit images around a barrier, such as a wall or door frame. By using the law enforcement aid, in conjunction with a portable receiver display, the officer is able to assess in real time the situation on the other side of the barrier. Alternatively, the present invention may be utilized by a plurality of law enforcement officers, wherein one officer uses portable camera surveillance device to capture and transmit images around an obstacle, while another officer uses portable receiver display in order to assess in real time the situation on the other side of the barrier. Additionally, alternative examples of usage of the present invention may include use of a law enforcement aid to transmit images to a remote receiver.

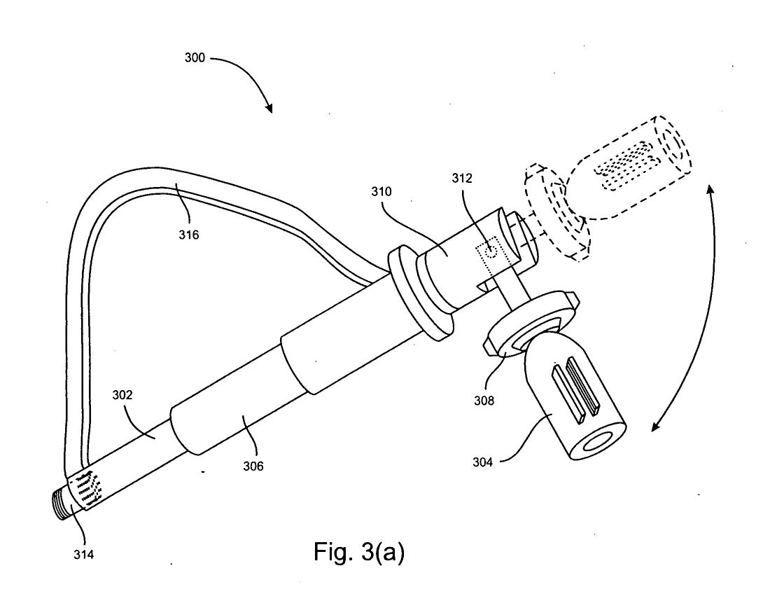

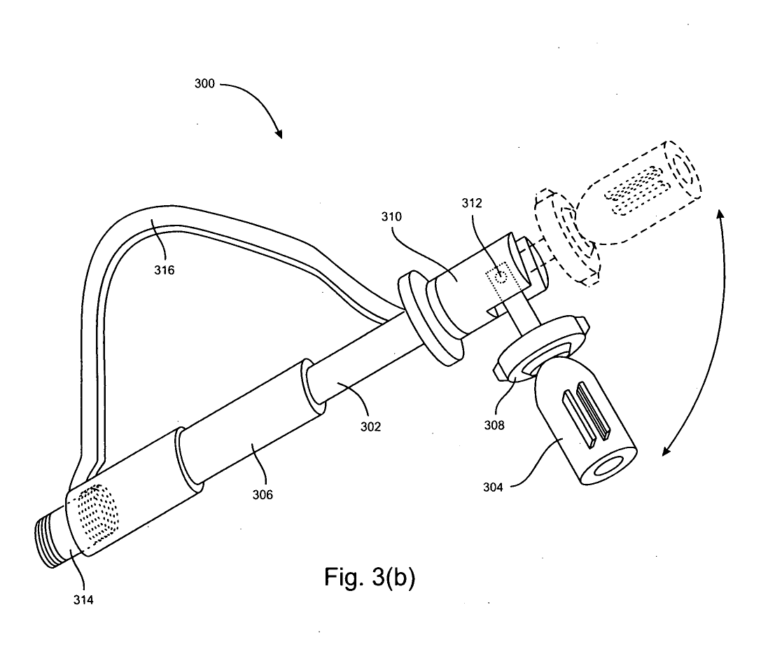

FIG. 3(a) illustrates a side view of an exemplary embodiment of a law enforcement aid. FIG. 3(b) illustrates a side view of another exemplary embodiment of a law enforcement aid. FIGS. 3(a) and 3(b) show law enforcement aid 300, comprising pole 302, portable camera 304, pole joint 306, pole mount 308, rotator 310, intermediary device 312, pole extender 314, and shoulder sling 316. Law enforcement aid 300 is designed to allow a user to capture and transmit images through portable camera 304, which may be extended and retracted at the end of pole 302.

Pole 302 is the main body of law enforcement aid 300. Pole 302 is an object designed to be extended or retracted in length. In an exemplary embodiment, pole 302 may have a telescopic structure, wherein pole 302 may comprise a plurality of nesting telescopic pole joints 306. Pole joints 306 may be extended to elongate pole 302, or retracted to shorten pole 302. In the embodiment of law enforcement aid 300 depicted in FIG. 3(a), the cross-section of each pole joint 306 may increase in size from a distal end of pole joint 306 to the proximal end of pole joint 306 at rotator 310, with the cross-section of each nested pole joint 306 being sequentially smaller than the pole joint 306 it is nested within along the length of pole 302. In the embodiment of law enforcement aid 300 depicted FIG. 3(b), however, the cross-section of each pole joint 306 may decrease in size from a distal end of pole joint 306 at rotator 310 to the proximal end of pole joint 306. As such, each pole joint 306 may slide upon the other, but pole joints 306 may not be removed from pole 302. Alternative embodiments of law enforcement aid 300, however, may include other means for extension and retraction of pole 302, such as parallel connected extendable members, screw-rotation motion, air or pneumatic expansion or retraction, or some type of material based elasticity. Therefore, the telescopic nature of pole 302 should not be interpreted so as to limit the scope of the present invention.

Preferably, pole joints 306 may be rigid such that pole 302 may only extend and retract in length, and may not flex in any other direction. However, in alternative embodiments of law enforcement aid 300, pole joints 306 may flex or bend. In such embodiments of the present invention, pole 302 may be extended in a plurality of directions, allowing for extension and retraction of pole 302 around corners or potential obstacles that would stand in the way of one dimensional extension and retraction.

The maximum and minimum length of pole 302 may be modified by attaching or removing pole joints 306 via pole extender 314. Pole extender 314 is a component of law enforcement aid 300 that may couple one pole joint 306 to another pole joint 306. In an exemplary embodiment of the present invention, pole extenders 314 may be located at a distal and proximal ends of pole joint 306. Further, pole extender 314 at a distal end of pole joint 306 may comprise a male screw-type configuration, and pole extender 314 at a proximal end of pole joint 306 may comprise a female screw-type configuration. Additionally, pole extender 316 may comprise a universal rail mount connection to couple pole joints 306, or other connection methods.

In exemplary usage of law enforcement aid 300, a user may extend the length of pole 302 by applying an outward longitudinal force along the length of pole 302, thereby pulling or sliding pole joints 306 out from a nestled position. As pole joints 306 are pulled away from a nestled position, pole 302 extends and the length of pole 302 may increase. When all pole joints 306 have slid out to their maximum extended positions, pole 302 has reached its maximum length and may be extended no further. In further exemplary usage of law enforcement aid 300, a user may retract the length of pole 302 by applying an inward longitudinal force along the length of pole 302, thereby pushing or sliding pole joints 306 away from their maximum extended positions and into a nestled position. If pole joints 306 are pushed into a nestled position, pole 302 may retract and the length of pole 302 may decrease. When all pole joints 306 have slid into their minimum nestled positions, pole 302 has reached its minimum length and may be retracted no further.

Portable camera 304 is a component of law enforcement aid 300 that may capture and transmit images. Portable camera 304 may be securely attached to or removed from pole mount 308. Pole mount 308 is a component of law enforcement aid 300 that couples pole 302 to portable camera 304. In an exemplary embodiment of the present invention, pole mount 308 may be located at a proximal end of pole 302. Additionally, pole mount 308 may preferably comprise a universal rail mount connection to couple to portable camera 304. In other embodiments, pole mount 308 may include a male and female screw-type configuration or other type of connection method.

In exemplary usage of law enforcement aid 300, a user may attach portable camera 304 to pole mount 308, extend pole 302 to a desired length and, while holding pole 302, manipulate pole 302 in order to move portable camera 304 to a desired position. In such usage of law enforcement aid 300, pole 302 may be extended in length so that a user may capture and transmit images via portable camera 304 from locations inconvenient, unsafe, or inaccessible to a user not using law enforcement aid 300. Additionally, exemplary usage of law enforcement aid 300 may include where a user may detach portable camera 304 from pole mount 308, and pole 302 may be retracted to its minimum length for convenient storage or transportation of law enforcement aid 300. Thus, law enforcement aid 300, when disassembled, will require less volume for storage and may be easier to transport. Alternatively, to easier transport law enforcement aid 300, a user may attach shoulder sling 316 to carry law enforcement aid 300 over the shoulder.

Rotator 310 and intermediary device 312 are optional components of law enforcement aid 300 that couple pole mount 308 to pole 302. Rotator 310 may be coupled to pole mount 308 and intermediary device 312. Intermediary device 312 may then be coupled to rotator 310 and pole 302. In an exemplary embodiment of the present invention, pole mount 308 may be rotated along a circumferential path, wherein the radius is rotator 310 and center is the connection between rotator 310 and intermediary device 312. Additionally, intermediary device 312 may include a knob or other like component to tighten or release rotator 310 from alignment with respect to intermediary device 312. A user may loosen intermediary device 312, thereby releasing rotator 310 from a position, allowing rotator 310 to be moved along a circumferential path. A user may then tighten intermediary device 312, securely locking rotator 310 into its position. Therefore, in exemplary usage of law enforcement aid 300, portable camera 304 may be more easily pointed in a desired direction, or around a corner or obstacle, by a user holding pole 302, through the manipulation of the angle between pole 302 and pole mount 308 by rotator 310.

Shoulder sling 316 is a component of law enforcement aid 300 that may attach to pole joints 306. Shoulder sling 316 may comprise a strap, sling, band, leash, tie, or other securing mechanism in which a user may secure or hold law enforcement aid 300. In exemplary usage, shoulder sling 316 may be put over a user's shoulder in order to transport law enforcement aid 300. Shoulder sling 316 may be attached to and removed from pole joints 306 by being tied, mechanically attached, snapped, magnetism, or some other method. In an alternative embodiment of the present invention, shoulder sling 316 may be permanently secured to pole joints 306. Furthermore, shoulder sling 316 may be attached to a holster, pouch or other appropriate storage mechanism for carrying portable receiver (not shown) as one unit. Thus, a user is able to conveniently carry law enforcement aid 300 with portable receiver lodged in a holster or carrying pouch for complete transport.

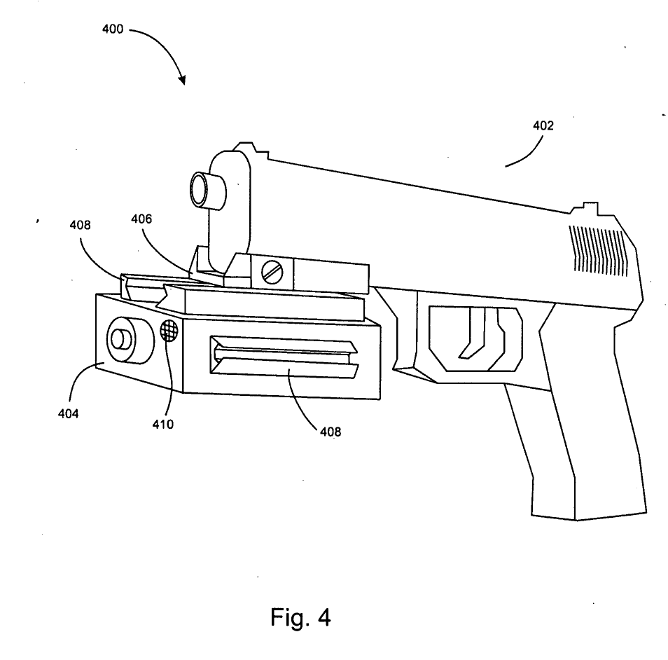

FIG. 4 illustrates a perspective view of an exemplary embodiment of a law enforcement aid. FIG. 4 shows law enforcement aid 400, comprising weapon 402, portable camera 404, weapon mount 406, portable camera connector 408 and audio recording component 410. Law enforcement aid 400 is designed to allow a user to capture and transmit images through portable camera 404, which may be attached or removed from a mount on weapon 402.

Weapon 402 is a component of law enforcement aid 400. While the present embodiment of law enforcement aid 400 may depict weapon 402 comprising a handgun, weapon 402 may comprise a rifle, shotgun, or any type of law enforcement device, firearm, less lethal weapon, taser, or other like device. Weapon mount 406 is a component of law enforcement aid 400 coupled to the exterior housing of weapon 402. Weapon mount 406 is designed to securely couple portable camera connector 408 to weapon 402. Law enforcement aid 400 may include a plurality of weapon mounts 406. In an exemplary embodiment of law enforcement aid 400, weapon mount 406 may comprise a universal rail mount connection to couple to portable camera connector 408. In other embodiments of law enforcement aid 400, however, weapon mount 406 may include a male and female screw-type configuration or other type of connection method.

Portable camera 404 is a component of law enforcement aid 400 that may capture and transmit images. Portable camera 404 may be securely attached to or removed from weapon mount 406 via portable camera connector 408. Portable camera connector 408 is a component portable camera 404 that couples portable camera 404 to weapon 402. In an exemplary embodiment of law enforcement aid 400, portable camera connector 408 may comprise a universal rail mount connection to couple to weapon mount 406. In other embodiments of law enforcement aid 400, however, portable camera connector 408 may include a male and female screw-type configuration or other type of connection method.

In exemplary usage of law enforcement aid 400, a user may attach portable camera 404 to weapon mount 406 such that portable camera 404 captures and transmits images of wherever weapon 402 is aimed as well as audio feedback that is captured by audio recording component 410. Additionally, a user may detach portable camera 404 from weapon 402 when not in use or for portable camera 404 power source recharge, disposal or replacement.

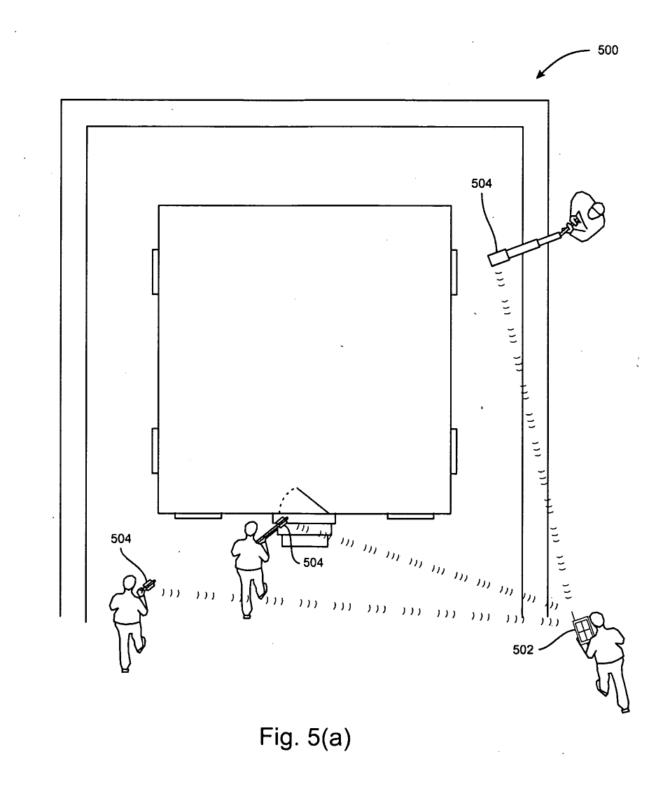

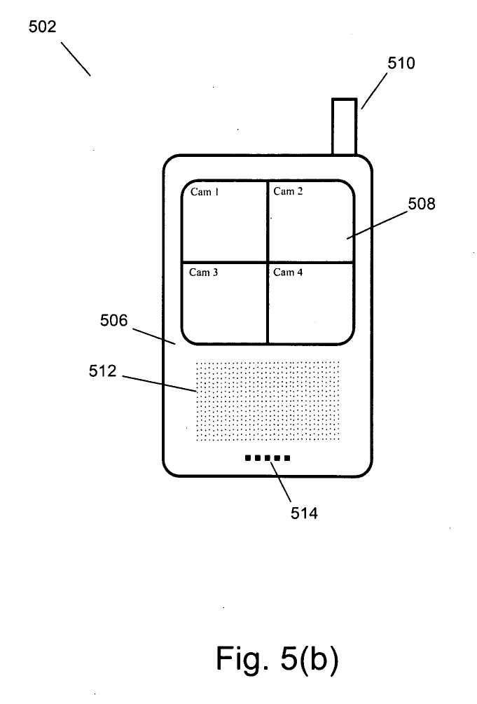

FIG. 5(a) illustrates an overhead view of an exemplary use of a camera surveillance system in accordance with the present invention. In FIG. 5(a), law enforcement officers may utilize a plurality of portable cameras 504 to transmit images to portable receiver 502. FIG. 5(b) illustrates a front elevational view of a portable receiver in a camera surveillance system. FIGS. 5(a) and 5(b) illustrate camera surveillance system 500, which comprises portable receiver 502 and portable cameras 504. Portable receiver 502 comprises receiver housing 506, display 508, antenna 510, audio output 512, and audio input 514. Camera surveillance system 500 is designed to provide a user of portable receiver 502 images from a plurality of portable cameras 504.

Portable receiver 502 is a component of camera surveillance system 500 designed to receive and display images captured and transmitted by portable camera 504. Camera surveillance system 500 may comprise one or more of portable receivers 502. In an exemplary embodiment of the present invention, each portable receiver 502 may receive and display a plurality of images captured and transmitted by a plurality of portable cameras 504. While FIGS. 5(a) and 5(b) illustrate portable receiver 502 capable of receiving and displaying images captured and transmitted by four portable cameras 504, in another embodiment of the present invention, portable receiver 502 may display images received from a single portable camera 504. Therefore, the number of images displayed by portable receiver 502 and the number of portable cameras 504 should not be interpreted so as to limit the scope of the present invention.

In exemplary usage of camera surveillance system 500, each member of a team of law enforcement officers may utilize a portable receiver 502 and a portable camera 504. In such a situation, each law enforcement officer may transmit images they capture with portable camera 504. Additionally, each law enforcement officer may display on portable receiver 502 images received from the portable cameras 504 of other law enforcement officers. In other exemplary usage of camera surveillance system 500, a single portable receiver 502 may be utilized by an officer, who may interpret images received from one or more portable cameras 504.

In alternative embodiments of the present invention, receiver 502 may comprise video and audio storage as well as recording capabilities. In such an embodiment, receiver 502 may comprise a hard drive, flash memory, temporary cache, tape, or some other data storage medium. In usage of such an embodiment, a user may record video for later playback, storage, transmission or analysis.

Receiver housing 506 is the main body of portable receiver 502. Receiver housing 506 is an object designed to enclose the interior components of portable receiver 502. In an exemplary embodiment of camera surveillance system 500, portable receiver 502 may be lightweight and small such that it may be easily transported and stored by a user, but also to be rigid to maintain a pre-molded shape, and durable and able to withstand the impacts of frequent use. Receiver housing 506 may be composed of a variety of materials, such as metals, plastics, or alloys. This list is not exhaustive, however, and should not be interpreted so as to limit the scope of the present invention. In an exemplary embodiment, housing 102 may be rectangular in shape; however, in other embodiments, housing 102 may be cylindrical, flattened cylindrical, conical, cubical, or another shape configuration or combination thereof.

Display 508 is a component of portable receiver 502 designed to provide a visual representation of images received by antenna 510. In an exemplary embodiment of the present invention, display 508 may be securely enclosed within receiver housing 506, visible to the user. While an exemplary embodiment of the present invention comprises display 508 including a liquid crystal display, the method of display should not be interpreted to limit the scope of the present invention. Display 508 may comprise a liquid crystal display, light emitting diodes, cathode ray tube, liquid crystal on silicon, or other display technology. Additionally, display 508 may include a backlight and provide a visual output in a plurality of colors in the visual spectrum.

Antenna 510 is a component of portable receiver 502 designed to receive images transmitted by portable cameras 504. Antenna 510 may be located within receiver housing 506, or may be external to receiver housing 506. Antenna 510 is connected to display 508 such that display 508 may display images received by antenna 510. In an exemplary embodiment, antenna 510 may receive transmissions on the industrial, scientific, and medical radio (ISM) bands. However, antenna 510 may be configured to receive transmissions on a wide number of other electromagnetic frequencies. Further, antenna 510 may be configured to wirelessly interface directly with a remote device, i.e. Bluetooth protocol, or may be configured to receive images utilizing a wireless network protocol. Additionally, in another embodiment of the present invention, antenna 510 may be adapted to transmit data, command information, or other types of communication in addition to the reception of image transmissions.

Audio output 512 and audio input 514 are optional components of portable receiver 502 that may be designed to provide two-way audio communication to users of camera surveillance system 500. In an exemplary embodiment of the present invention, audio output 512 may comprise a speaker or like device, and audio input 514 may comprise a microphone or like device. In exemplary functionality of the present invention, outgoing audio communication may be audibly inputted through audio input 514 by a user of portable receiver 502 and then transmitted by antenna 510 to other portable receivers 502. Likewise, incoming audio communication may be received by antenna 510 and audibly outputted through audio output 512 to a user of portable receiver 502. Additionally, portable receiver 502 may be configured such that antenna 510 may send and receive audio communication to and from devices other than portable receiver 502, such as cellular phones, two-way radios or other communication devices.

A portable camera and surveillance device has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A portable camera, comprising:
a housing including a universal connector capable of securely attaching to a plurality of distinct support structures;
an image-capturing element disposed within the housing, wherein the image-capturing element is adapted to generate an image signal in response to detecting electromagnetic energy; and
a transmitter disposed within the housing, wherein the transmitter is adapted to transmit the image signal.

2. The portable camera of claim 1, wherein one of the distinct support structures comprises a pole.

3. The portable camera of claim 2, wherein the pole is extendable and retractable.

4. The portable camera of claim 2, wherein the housing is adapted to pivotally attach to the pole.

5. The portable camera of claim 4, wherein the housing is adapted to pivotally attach to the pole by the universal connector attaching to an intermediary device that is pivotally coupled to the pole.

6. The portable camera of claim 5, wherein the intermediary device comprises a rotator situated within a groove of the pole.

7. The portable camera of claim 1, wherein one of the distinct support structures comprises a weapon.

8. The portable camera of claim 7, wherein the weapon comprises a rifle.

9. The portable camera of claim 7, wherein the weapon comprises a handgun.

10. The portable camera of claim 7, wherein the weapon comprises a shotgun.

11. The portable camera of claim 1, wherein the housing comprises a plurality of universal connectors at different positions on the housing.

12. The portable camera of claim 1, wherein the housing further comprises an audio recording component.

13. The portable camera of claim 1, wherein one of the distinct support structures comprises a helmet.

14. The portable camera of claim 1, wherein the universal connector comprises a picatinny universal mount.

15. The portable camera of claim 1, wherein the universal connector comprises a first rail adapted to slide upon a corresponding second rail on the support structure, and a locking mechanism to securely attach the first and second rails together.

16. The portable camera of claim 1, further comprising a power source adapted to supply power to the image-capturing element and the transmitter.

17. The portable camera of claim 16, wherein the power source is disposed within the housing.

18. The portable camera of claim 1, further comprising a light source.

19. The portable camera of claim 18, wherein the light source is disposed within the housing.

20. The portable camera of claim 1, wherein the image-capturing element is adapted to produce still- or moving-images at a variety of wavelengths on the electromagnetic spectrum.

21. A law enforcement aid comprising:
an extendable and retractable pole; and
a portable camera, comprising:
a housing including a universal connector for securely attaching to the pole;
an image-capturing element disposed within the housing, wherein the image-capturing element is adapted to generate an image signal in response to detecting electromagnetic energy; and
a transmitter disposed within the housing, wherein the transmitter is adapted to transmit the image signal.

22. The law enforcement aid of claim 21, wherein the housing is adapted to mount at an end portion of the pole.

23. The law enforcement aid of claim 21, further comprising a strap adapted to mount at a distal and a proximal end of the pole.

24. A law enforcement aid comprising:
a weapon; and
a portable camera, comprising:
a housing including a universal connector for securely attaching to the weapon;
an image-capturing element disposed within the housing, wherein the image-capturing element is adapted to generate an image signal in response to detecting electromagnetic energy; and
a transmitter disposed within the housing, wherein the transmitter is adapted to transmit the image signal.

25. The law enforcement aid of claim 24, wherein the weapon comprises a rifle, shotgun, handgun, or other type of firearm.

26. A camera surveillance system comprising:
a plurality of portable cameras, each comprising:
a housing including a universal connector capable of securely attaching to a plurality of distinct support structures;
an image-capturing element disposed within the housing, wherein the image-capturing element is adapted to generate an image signal in response to detecting electromagnetic energy; and
a transmitter disposed within the housing, wherein the transmitter is adapted to transmit the image signal, and a portable receiver adapted to receive the image signal from each of the cameras, and provide a corresponding image on a display.

27. The camera surveillance system of claim 26, wherein the portable receiver simultaneously displays a plurality of images from respective cameras.

28. The camera surveillance system of claim 26, wherein the portable receiver includes a microphone, audio processor, and transmitter for audio communication and transmission.

29. The camera surveillance system of claim 26, further comprising a plurality of portable receivers, wherein each of the portable receivers are adapted to receive image signal from each of the cameras, and provide a corresponding image on a corresponding display.
